(19) United States
(12) Patent Application Publication
(10) Pub. No.: US 2017/0326009 A1
(43) Pub. Date: Nov. 16, 2017

(54) Lifting and Lowering Chair

(71) Applicant: Rikina Reisig, Huntsville, TX (US)

(72) Inventor: Rikina Reisig, Huntsville, TX (US)

(21) Appl. No.: 15/153,945

(22) Filed: May 13, 2016

(51) Int. Cl. A61G 5/14

(52) U.S. Cl. CPC A61G 5/14

(57) ABSTRACT

A lifting and lowering chair for lifting a user from and lowering a user to a surface includes a base and a seat. The base is configured to position on a surface. Each of a pair of lifts is coupled to a bottom of the seat proximate to a respective opposing side of the seat. Each lift is coupled to a top face of the base. Each of a pair of motors is operationally coupled to a respective lift. The motors are positioned to motivate the lifts to raise the seat to an extended position such that a user is lifted from a position proximate to the surface. The motors also are positioned to motivate the lifts to lower the seat to a retracted position, such that the user is lowered to a position proximate to the surface.

### BACKGROUND OF THE DISCLOSURE

### Field of the Disclosure

The disclosure relates to lifting and lowering chairs and more particularly pertains to a new lifting and lowering chair for lifting a user from and lowering a user to a surface.

### SUMMARY OF THE DISCLOSURE

An embodiment of the disclosure meets the needs presented above by generally comprising a base and a seat. The base is configured to position on a surface. Each of a pair of lifts is coupled to a bottom of the seat proximate to a respective opposing side of the seat. Each lift is coupled to a top face of the base. Each of a pair of motors is operationally coupled to a respective lift. The motors are positioned to motivate the lifts to raise the seat to an extended position such that a user is lifted from a position proximate to the surface. The motors also are positioned to motivate the lifts to lower the seat to a retracted position, such that the user is lowered to a position proximate to the surface.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a lifting and lowering chair according to an embodiment of the disclosure.

FIG. 2 is a side view of an embodiment of the disclosure.

FIG. 3 is a side view of an embodiment of the disclosure.

FIG. 4 is a rear view of an embodiment of the disclosure.

FIG. 5 is a bottom view of an embodiment of the disclosure.

### DESCRIPTION OF THE PREFERRED EMBODIMENT

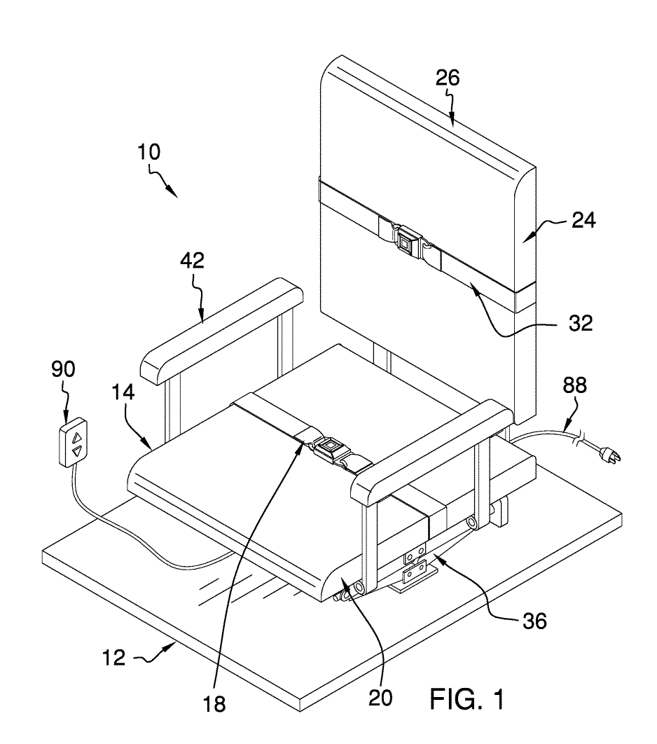

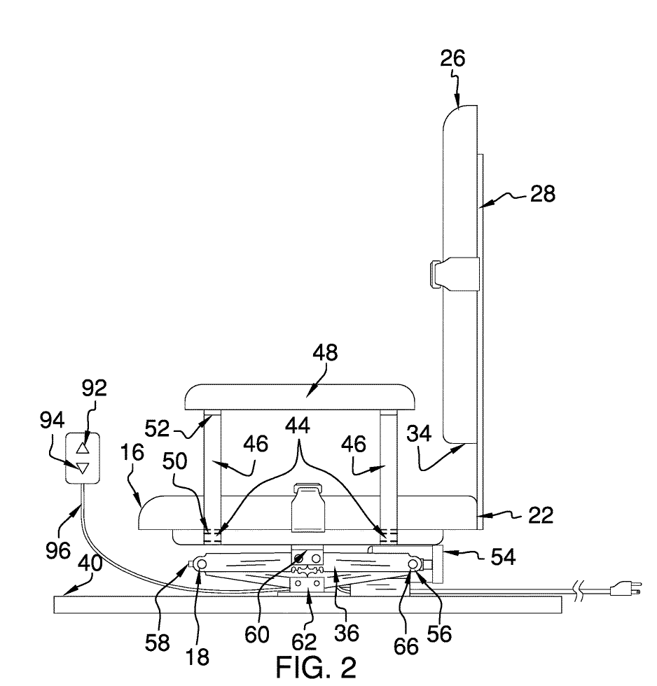

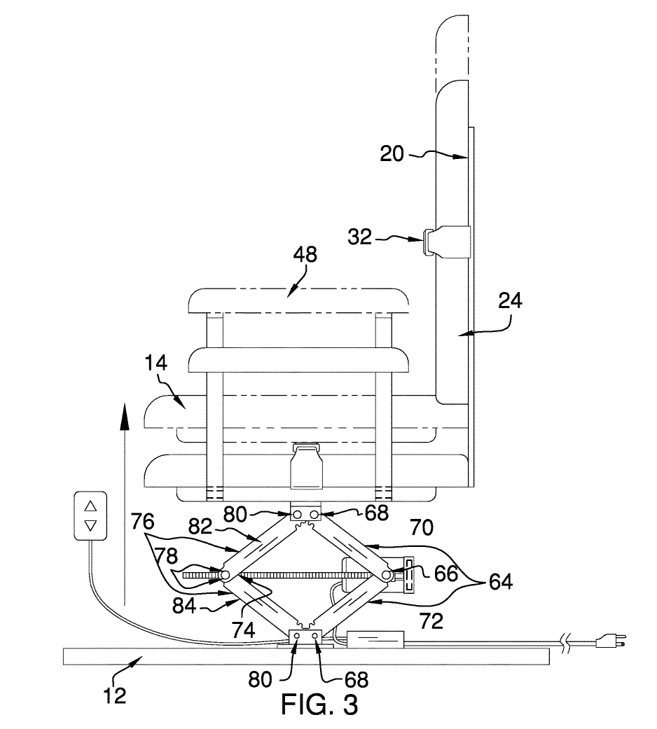

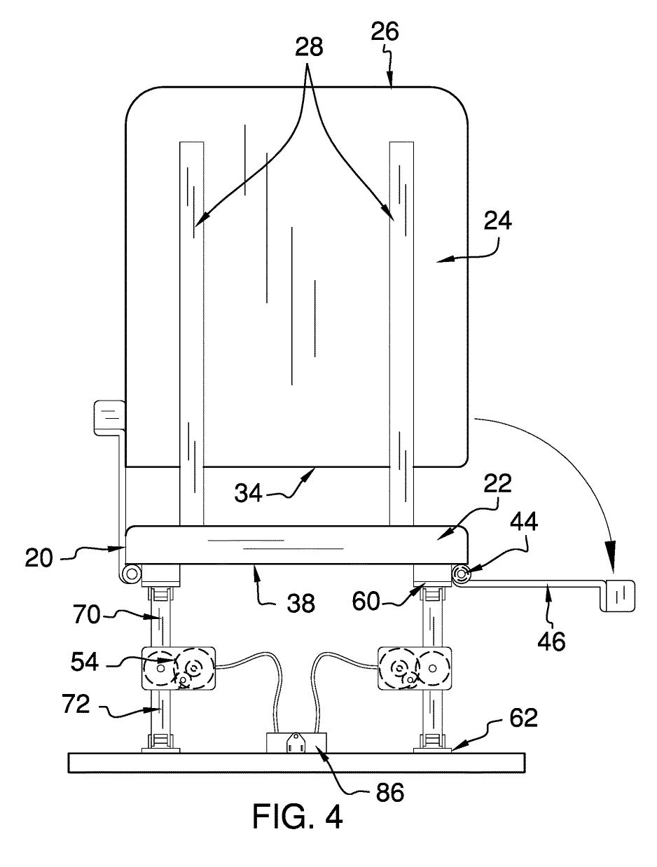

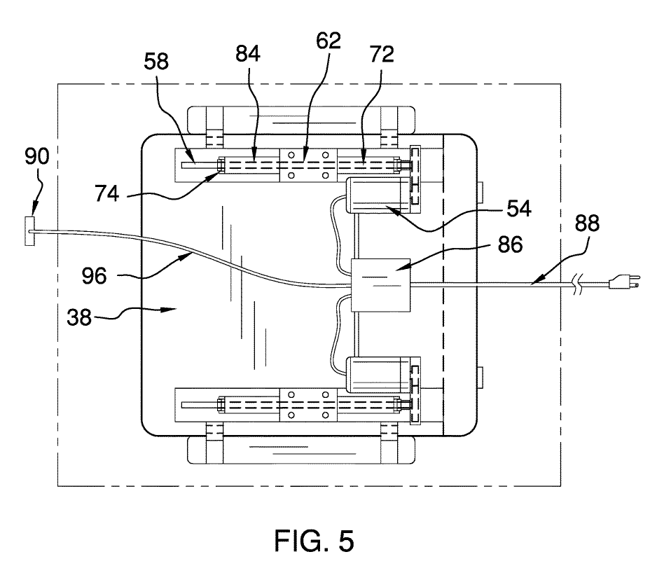

With reference now to the drawings, and in particular to FIGS. 1 through 5 thereof, a new lifting and lowering chair embodying the principles and concepts of an embodiment of the disclosure and generally designated by the reference numeral 10 will be described.

As best illustrated in FIGS. 1 through 5, the lifting and lowering chair 10 generally comprises a base 12 that is configured to position on a surface. The base 12 is substantially rectangularly shaped. The chair 10 comprises a seat 14 that is substantially rectangularly shaped. In one embodiment, the seat 14 is square. The seat 14 has a front edge 16 that is rounded.

A first seat belt 18 is coupled to and extends between respective opposing sides 20 of the seat 14. The first seat belt 18 is positioned substantially equally distant from a rear edge 22 and the front edge 16 of the seat 14. The first seat belt 18 is configured to attach across a lap of a user to secure the user to the seat 14.

A back 24 is coupled to the rear edge 22 of the seat 14. The back 24 is positioned on the seat 14 such that the back 24 is configured to support the user positioned in the seat 14. The back 24 is substantially rectangularly shaped. The back 24 has an upper edge 26 that is rounded. In one embodiment, a pair of supports 28 is coupled to the seat 14 and extends substantially perpendicularly from the rear edge 22 of the seat 14. Each support 28 is positioned proximate to a respective opposing side 20 of the seat 14. The back 24 is coupled to the front face 30 of each support 28.

A second seat belt 32 is coupled to and extends between the pair of supports 28. The second seat belt 32 is positioned substantially equally distant from the upper edge 26 and a lower edge 34 of the back 24. The second seat belt 32 is configured to attach across a torso of the user to secure the user to the back 24.

Each of a pair of lifts 36 is coupled to a bottom 38 of the seat 14 proximate to the respective opposing side 20 of the seat 14. Each lift 36 is coupled to a top face 40 of the base 12.

Each of a pair of handrails 42 is pivotally coupled singly to the opposing sides 20 of the seat 14. The handrails 42 are positioned on the seat 14 such that the handrails 42 are configured to pivot to a position substantially parallel to the seat 14 for side entry of the user to the seat 14. The handrails 42 also are positioned to pivot to a position substantially perpendicular to the seat 14 to support the user positioned in the seat 14.

Each handrail 42 comprises a pair of hinges 44, a pair of verticals 46 and a lateral 48. The hinges 44 are spring-loaded. Each hinge 44 is coupled to the respective opposing side 20 of the seat 14. The hinges 44 are positioned singly proximate to the rear edge 22 and the front edge 16 of the seat 14. Each vertical 46 has a first end 50 that is coupled to a respective hinge 44. The lateral 48 is coupled to and extends between second ends 52 of the verticals 46. The hinges 44 are positioned to bias the verticals 46 to a position substantially perpendicular to the seat 14.

Each of a pair of motors 54 is operationally coupled to a respective lift 36. In one embodiment, each lift 36 comprises a guide ring 56 that is coupled to a respective motor 54. The lift 36 also comprises a screw 58 that is complementary to and positioned through the guide ring 56. The screw 58 is operationally coupled to the respective motor 54. A top bracket 60 is coupled to the bottom 38 of the seat 14 and a bottom bracket 62 is coupled to the top face 40 of the base 12. A pair of rear arms 64 has first endpoints 66 that are pivotally coupled to the guide ring 56. A second endpoint 68 of an upper rear arm 70 is pivotally coupled to the top bracket 60. A second endpoint 68 of a lower rear arm 72 is pivotally coupled to the bottom bracket 62. A thread gear 74 is threadedly coupled to the screw 58 distal from the motor 54. A pair of front arms 76 has first termini 78 that are pivotally coupled to the thread gear 74. A second terminus 80 of an upper front arm 82 is pivotally coupled to the top bracket 60. A second terminus 80 of a lower front arm 84 is pivotally coupled to the bottom bracket 62. The motor 54 is positioned to rotate the screw 58 such that the thread gear 74 is motivated along the screw 58. The pair of front arms 76 and the pair of rear arms 64 are pivoted to raise the seat 14 to an extended position and to lower the seat 14 to a retracted position.

A switch box 86 is coupled to the base 12. The switch box 86 is operationally coupled to the pair of motors 54. A power cord 88 is operationally coupled to and extends from the switch box 86. The power cord 88 is configured to electrically couple the switch box 86 to a power source. A controller 90 is operationally coupled to the switch box 86. The controller 90 is positioned to signal the switch box 86 to engage the motors 54 to motivate the lifts 36. The controller 90 comprises an Up button 92 and a Down button 94. A cable 96 is operationally coupled to and extends between the controller 90 and the switch box 86. The cable 96 is coupled to the switch box 86 such that the controller 90 is configured to position proximate to the user.

In use, the chair 10 is configured to position proximate to a user. The power cord 88 is configured to electrically couple the switch box 86 to a power source. The controller 90 is positioned to signal the switch box 86 to engage the motors 54 to motivate the lifts 36. The motors 54 are positioned to motivate the lifts 36 to raise the seat 14 to an extended position, such that the user is lifted from a position proximate to the surface. The motors 54 also are positioned to motivate the lifts 36 to lower the seat 14 to a retracted position, such that the user is lowered to a position proximate to the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lifting and lowering chair comprising:
a base configured for positioning on a surface;
a seat;
a pair of lifts, each said lift being coupled to a bottom of said seat proximate to a respective opposing side of said seat, each said lift being coupled to a top face of said base;
a pair of motors, each said motor being operationally coupled to a respective said lift; and
wherein said motors are positioned to motivate said lifts to raise said seat to an extended position such that a user is lifted from a position proximate to the surface, and wherein said motors are positioned to motivate said lifts to lower said seat to a retracted position, such that the user is lowered to a position proximate to the surface.

2. The chair of claim 1, further including said base being substantially rectangularly shaped.

3. The chair of claim 1, further including said seat being substantially rectangularly shaped.

4. The chair of claim 2, further including said seat being square.

5. The chair of claim 1, further including said seat having a front edge, said front edge being rounded.

6. The chair of claim 1, further including a first seatbelt coupled to and extending between said respective said opposing sides of said seat substantially equally distant from a rear edge and a front edge of said seat, wherein said first seatbelt is configured to attach across a lap of the user to secure the user to said seat.

7. The chair of claim 1, further including a back coupled to a rear edge of said seat, wherein said back is positioned on said seat such that said back is configured to support the user positioned in said seat.

8. The chair of claim 7, further including said back being substantially rectangularly shaped.

9. The chair of claim 7, further including said back having an upper edge, said upper edge being rounded.

10. The chair of claim 7, further including a pair of supports coupled to said seat and extending substantially perpendicularly from said rear edge of said seat, each said support being positioned proximate to a respective said opposing side of said seat, said back being coupled to a front face of each said support.

11. The chair of claim 10, further including a second seatbelt coupled to and extending between said pair of supports, said second seatbelt being positioned substantially equally distant from an upper edge and a lower edge of said back, wherein said second seatbelt is configured to attach across a torso of the user to secure the user to said back.

12. The chair of claim 1, further including a pair of handrails pivotally coupled singly to said respective said opposing sides of said seat, wherein said handrails are positioned on said seat such that said handrails are configured to pivot to a position substantially parallel to said seat for side entry of the user to said seat, and wherein said handrails are positioned to pivot to a position substantially perpendicular to said seat to support the user positioned in said seat.

13. The chair of claim 12, further including each said handrail comprising:
a pair of hinges, said hinges being spring-loaded, each said hinge being coupled to said respective said opposing side of said seat, said hinges being positioned singly proximate to a rear edge and a front edge of said seat,
a pair of verticals, each said vertical having a first end, each said first end being coupled to a respective said hinge,
a lateral coupled to and extending between second ends of said verticals, and
wherein said hinges are positioned to bias said verticals to a position substantially perpendicular to said seat.

14. The chair of claim 1, further including each said lift comprising:
a guide ring coupled to a respective said motor;
a screw complementary to and positioned through said guide ring, said screw being operationally coupled to said respective said motor;
a top bracket coupled to said bottom of said seat;
a bottom bracket coupled to said top face said base;
a pair of rear arms having first endpoints pivotally coupled to said guide ring, a second endpoint of an upper rear arm being pivotally coupled to said top bracket, a second endpoint of a lower rear arm being pivotally coupled to said bottom bracket;
a thread gear threadedly coupled to said screw distal from said motor;
a pair of front arms having first termini pivotally coupled to said thread gear, a second terminus of an upper front arm being pivotally coupled to said top bracket, a second terminus of a lower front arm being pivotally coupled to said bottom bracket; and
wherein said motor is positioned to rotate said screw such that said thread gear is motivated along said screw, wherein said pair of front arms and said pair of rear arms are pivoted to raise said seat to an extended position and to lower said seat to a retracted position.

15. The chair of claim 1, further including a switch box coupled to said base, said switch box being operationally coupled to said pair of motors.

16. The chair of claim 15, further including a power cord operationally coupled to and extending from said switch box, wherein said power cord is configured to electrically couple said switch box to a power source.

17. The chair of claim 16, further including a controller operationally coupled to said switch box, wherein said controller is positioned to signal said switch box to engage said motors to motivate said lifts.

18. The chair of claim 17, further including said controller comprising Up button and a Down button.

19. The chair of claim 17, further including a cable operationally coupled to and extending between said controller and said switch box, wherein said cable is coupled to said switch box such that said controller is configured for positioning proximate to the user.

20. A lifting and lowering chair comprising:
a base configured for positioning on a surface, said base being substantially rectangularly shaped;
a seat, said seat being substantially rectangularly shaped, said seat being square, said seat having a front edge, said front edge being rounded;
a first seatbelt coupled to and extending between said respective said opposing sides of said seat substantially equally distant from a rear edge and said front edge of said seat, wherein said first seatbelt is configured to attach across a lap of a user to secure the user to said seat;
a back coupled to said rear edge of said seat, wherein said back is positioned on said seat such that said back is configured to support the user positioned in said seat, said back being substantially rectangularly shaped, said back having an upper edge, said upper edge being rounded;
a pair of supports coupled to said seat and extending substantially perpendicularly from said rear edge of said seat, each said support being positioned proximate to a respective opposing side of said seat, said back being coupled to a front face of each said support,
a second seatbelt coupled to and extending between said pair of supports, said second seatbelt being positioned substantially equally distant from said upper edge and a lower edge of said back, wherein said second seatbelt is configured to attach across a torso of the user to secure the user to said back;
a pair of lifts, each said lift being coupled to a bottom of said seat proximate to said respective said opposing side of said seat, each said lift being coupled to a top face of said base;
a pair of handrails pivotally coupled singly to said respective said opposing sides of said seat, wherein said handrails are positioned on said seat such that said handrails are configured to pivot to a position substantially parallel to said seat for side entry of the user to said seat, and wherein said handrails are positioned to pivot to a position substantially perpendicular to said seat to support the user positioned in said seat;
each said handrail comprising:
a pair of hinges, said hinges being spring-loaded, each said hinge being coupled to said respective said opposing side of said seat, said hinges being positioned singly proximate to said rear edge and said front edge of said seat,
a pair of verticals, each said vertical having a first end, each said first end being coupled to a respective said hinge,
a lateral coupled to and extending between second ends of said verticals, and
wherein said hinges are positioned to bias said verticals to a position substantially perpendicular to said seat;
a pair of motors, each said motor being operationally coupled to a respective said lift;
each said lift comprising:
a guide ring coupled to a respective said motor,
a screw complementary to and positioned through said guide ring, said screw being operationally coupled to said respective said motor,
a top bracket coupled to said bottom of said seat,
a bottom bracket coupled to said top face of said base,
a pair of rear arms having first endpoints pivotally coupled to said guide ring, a second endpoint of an upper rear arm being pivotally coupled to said top bracket, a second endpoint of a lower rear arm being pivotally coupled to said bottom bracket,
a thread gear threadedly coupled to said screw distal from said motor,
a pair of front arms having first termini pivotally coupled to said thread gear, a second terminus of an upper front arm being pivotally coupled to said top bracket, a second terminus of a lower front arm being pivotally coupled to said bottom bracket, and
wherein said motor is positioned to rotate said screw such that said thread gear is motivated along said screw, wherein said pair of front arms and said pair of rear arms are pivoted to raise said seat to an extended position and to lower said seat to a retracted position;
a switch box coupled to said base, said switch box being operationally coupled to said pair of motors;
a power cord operationally coupled to and extending from said switch box, wherein said power cord is configured to electrically couple said switch box to a power source;
a controller operationally coupled to said switch box, wherein said controller is positioned to signal said switch box to engage said motors to motivate said lifts, said controller comprising Up button and a Down button;
a cable operationally coupled to and extending between said controller and said switch box, wherein said cable is coupled to said switch box such that said controller is configured for positioning proximate to the user; and
wherein said motors are positioned to motivate said lifts to raise said seat to an extended position such that the user is lifted from a position proximate to the surface, and wherein said motors are positioned to motivate said lifts to lower said seat to a retracted position, such that the user is lowered to a position proximate to the surface.
